(19) United States
(12) Patent Application Publication
(10) Pub. No.: US 2020/0387159 A1
(43) Pub. Date: Dec. 10, 2020

(54) ADJUSTMENT UNIT FOR ORIENTING VEHICLE SENSORS AND CAMERAS ON A MOTOR VEHICLE

(71) Applicant: TKR Spezialwerkzeuge GmbH, Gevelsberg (DE)

(72) Inventor: Torsten Kreischer, Wetter (DE)

(21) Appl. No.: 16/891,818

(22) Filed: Jun. 3, 2020

(30) Foreign Application Priority Data
Jun. 6, 2019 (DE) 10 2019 115 372.7

(51) Int. Cl. G05D 1/00; G08G 1/16

(52) U.S. Cl. CPC G05D 1/0094; G08G 1/164

(57) ABSTRACT

An adjustment unit for orienting vehicle sensors and/or cameras on a motor vehicle. In order to provide an adjustment unit for orienting vehicle sensors and/or cameras on a motor vehicle that allows for convenient and reliable adjustment of the vehicle sensors and/or cameras, the adjustment unit is composed of a base support for adjustably receiving an orientation element, a travel unit connected to the base support, a position detection unit connected to the travel unit for determining the position of the orientation element relative to the vehicle sensors and/or cameras, and a central control unit for automatically controlling and orienting the travel unit and the orientation element relative to the motor vehicle.

The invention relates to an adjustment unit for orienting vehicle sensors and/or cameras on a motor vehicle.

Modern motor vehicles comprise a plurality of vehicle sensors and/or cameras that are used for operating different assistance systems that assist the driver in particular driving situations during operation of the motor vehicle. Possible functionalities of the assistance systems include, for example, a lane departure warning system, adaptive cruise control, a lane change assistant and an emergency brake assistant. Assistance systems use different sensors, for example ultrasound sensors or radar, lidar or cameras, to determine the required environmental information such that also accidents can be prevented or the consequences thereof can at least be mitigated.

A prerequisite for the proper functioning of the systems that rely on the sensors and cameras is that said sensors and cameras are precisely oriented along the axis of travel. After having to exchange the sensors and/or cameras, for example within the scope of post-accident repairs, it is essential to adjust the cameras and/or sensors in order to ensure functioning of the assistance systems. At present, orientation usually takes place with the aid of so-called calibration panels, which must be precisely oriented relative to the motor vehicle. Precise positioning of the vehicle relative to the calibration panels is crucial for precise orientation of the vehicle, position detectors having to be positioned on the vehicle for this purpose.

The adjustment procedure that has to be carried out during workshop operations therefore requires considerable outlay and must be carried out with great care in order to ensure precise orientation of the sensors and/or cameras used for the functioning of the assistance systems.

Proceeding from this, the object of the invention is to provide an adjustment unit for orienting vehicle sensors and/or cameras on a motor vehicle that allows for convenient and reliable adjustment of the vehicle sensors and/or cameras.

This object is solved according to the invention by an adjustment unit having the features of claim 1. Advantageous further embodiments of the invention are specified in the dependent claims.

The adjustment unit according to the invention for orienting vehicle sensors and/or cameras on a motor vehicle comprises
a base support for adjustably receiving an orientation element,
a travel unit connected to the base support,
a position detection unit connected to the travel unit for determining the position of the orientation element relative to the vehicle sensors and cameras, and
a central control unit for automatically controlling and orienting the travel unit and the orientation element relative to the motor vehicle.

The base support of the adjustment unit according to the invention is used to receive, in stationary manner, an orientation element, for example a calibration panel by means of which the orientation of the vehicle sensor and/or camera relative to the axis of travel can be adjusted and checked. The base support is designed to adjustably receive the orientation element such that the position of said orientation element can be precisely adjusted after the adjustment unit has been positioned, if necessary via adjustment relative to the base support. The base support is designed to detachably receive the orientation element such that the respectively required orientation elements can be used for different types of vehicle.

The orientation elements are positioned relative to the vehicle sensor and/or camera to be oriented by means of a travel unit that is connected to the base support and that makes it possible to position the base support relative to the vehicle freely in space. The travel unit may for example be a chassis comprising an electromotive drive connected to rollers that makes it possible to freely position the adjustment unit in a simple manner in space, in particular in the workshop, relative to the vehicle.

According to the invention, a position detection unit that is connected to the travel unit and that is designed to reliably detect the position of the adjustment unit relative to the motor vehicle is provided for positioning the positioning unit relative to the vehicle. The position detection unit for example comprises a LIDAR system, acceleration sensors, magnetic field sensors, inclination sensors and/or 3D cameras, which enable it to detect the vehicle such that the exact position of the orientation element relative to the vehicle sensors and/or cameras can be determined even without position detectors on the motor vehicle. By positioning the adjustment unit using the travel unit and by orienting the orientation element relative to the base support as required, the orientation element is positioned precisely relative to the vehicle. The orientation element is positioned by means of the central control unit, which is designed to automatically control and orient the travel unit and the orientation element relative to the motor vehicle.

After the adjustment activities to be carried out have been defined, the adjustment unit is automatically positioned relative to the motor vehicle by means of the control unit, the relevant vehicle-specific position data being stored in the control unit or in a database connected to the control unit for this purpose. The automatic orientation of the adjustment unit, with the control unit triggering a corresponding positioning via the travel unit for this purpose, means that no user involvement whatsoever is needed for orienting the orientation element. The position detection unit thereby ensures precise orientation of the orientation element relative to the vehicle, the adjustment unit entering the required position relative to the motor vehicle automatically once the vehicle type and the vehicle sensor(s) and/or camera(s) to be checked and/or oriented has/have been defined.

The adjustment unit according to the invention can therefore be universally used for various vehicle types and sensors and/or cameras, the control unit being able to retrieve the positioning and orientation data for the relevant activities. The adjustment unit according to the invention also makes it possible to orient cameras and sensors in a simple manner if it is necessary for this purpose to arrange orientation elements at several positions. The adjustment unit can therefore travel to the required positions one after the other by means of the travel unit in order to enable precise orientation.

Orientation of the orientation element can be achieved by means of the travel unit alone, said travel unit not only providing a means for moving the adjustment unit in space but also for rotating same, as a result of which the positioning can be carried out in a precise manner. According to a particularly advantageous embodiment of the invention, however, the orientation element is connected to an actuator that is arranged on the base support and that is connected to the control unit. The actuator may be any desired adjustment mechanism via which the orientation element, for example a calibration panel, is connected to the base support. If necessary, particularly precise orientation of the orientation element can be achieved by means of the actuator after positioning of the adjustment unit by means of the travel unit.

The adjustment unit can be operated in any desired manner, for example via input means such as keypads, touch screens, or the like, arranged thereon. According to a particularly advantageous embodiment of the invention, however, the control unit is connected to a communication unit for wireless data exchange. The communication unit enables particularly convenient operation of the adjustment unit, the communication unit making it possible to control the adjustment unit via Bluetooth, WLAN, WiFi, or the like. Additionally, the communication unit offers the possibility of querying the control unit directly at the vehicle, for example for reference data relating to the sensors or cameras to be adjusted. Furthermore, the adjustment unit can retrieve vehicle data from external databases. As a result, a particularly high adjustment quality of the cameras and sensors can be achieved.

The sensors to be adjusted and the vehicle type can in principle be defined in any desired manner, for example manually, wirelessly or directly at the adjustment unit. According to a particularly advantageous embodiment of the invention, however, the control unit is connected to a scanning unit for measuring and/or identifying a motor vehicle. The scanning unit therefore increases the degree of automation of the adjustment unit according to the invention in a complementary manner. Measurement can be carried out, for example, by optical means or by laser measurement, which can also be used to carry out any required lane measurements and/or steering angle measurements in a particularly reliable manner. The scanning unit also makes it possible to detect the orientation of the motor vehicle based on the loading state thereof, such that the orientation of the orientation element can be corrected accordingly by means of the control unit.

According to a further embodiment of the invention it is also provided that the control unit is connected to an obstacle detection unit. An obstacle detection unit ensures that the adjustment unit does not collide with obstacles possibly located within the travel range during autonomous operation of the adjustment unit. The obstacle detection may for example take place on the basis of lidar sensors, ultrasound sensors or cameras.

In order to orient the adjustment unit relative to the motor vehicle, the position detection unit may be provided with suitable sensors, for example acceleration sensors, magnetic field sensors, inclination sensors, which allow for precise orientation of the orientation element relative to the motor vehicle. According to a further embodiment of the invention it is provided that the position detection unit comprises a device for measuring the path. This is based, for example, on optical path sensors or rotary encoders and increases the accuracy of the positioning of the adjustment unit in a complementary manner. Thereby the path measurement allows for precise monitoring of the value traveled and the direction.

According to a further embodiment of the invention it is also provided that the adjustment unit comprises a signaling unit for protecting the surroundings. This may for example involve warning lights, such as rotating lights, which signal the adjustment procedure to the surroundings during operation of the adjustment unit, in particular during travel.

An exemplary embodiment of the invention will be described below, with reference to the drawings. In the drawings:

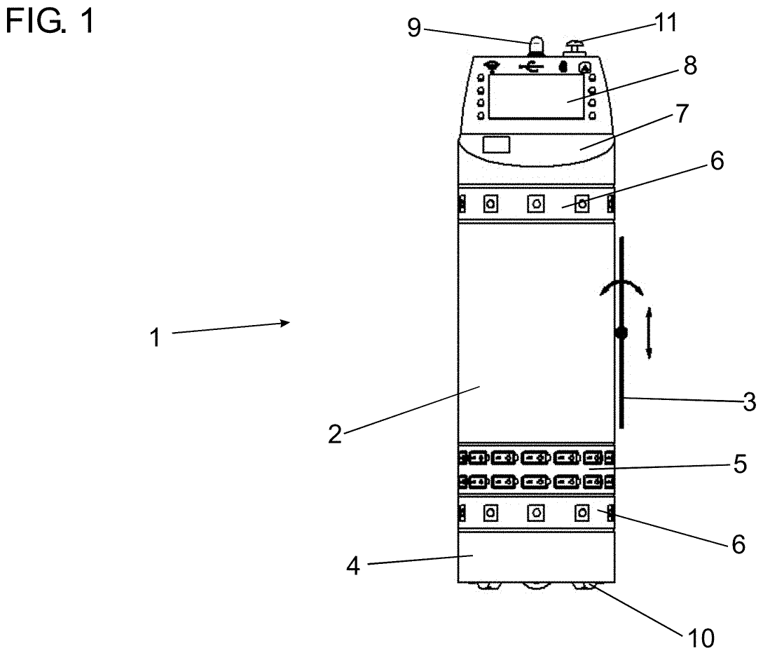

FIG. 1 shows a schematic representation of an adjustment unit in a side view and

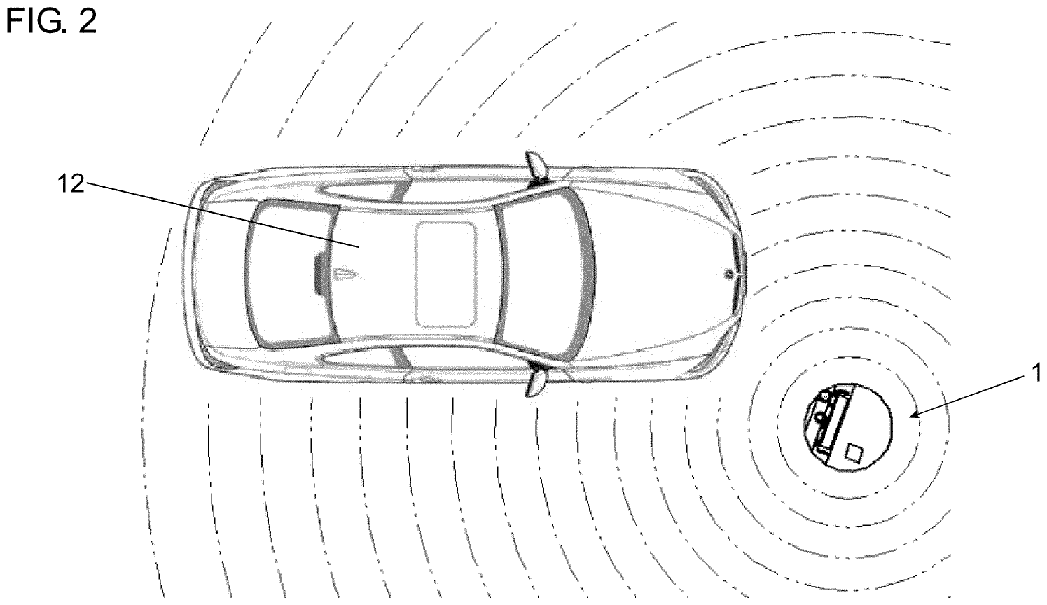

FIG. 2 shows a schematic representation of the arrangement of the adjustment unit from FIG. 1 relative to a motor vehicle.

In FIG. 1, an adjustment unit 1 is shown in a side view. Said unit comprises a base support 2, on which an orientation element 3 that is adjustable in height and that can tilt relative to the base support 2 is arranged. The base support 2 is connected to a travel unit that is designed as a chassis 4 and that allows for automatic movement of the adjustment unit 1 in space relative to a motor vehicle 12 (cf. FIG. 2).

A battery module 5 is provided for supplying power to the adjustment unit 1 and for supplying power to all units of the adjustment unit 1. Said units, in addition to the sensor modules 6 that are connected to a position detection unit (not shown here), also include the central control unit (not shown here) for automatically controlling and orienting the travel unit and the orientation element 3 relative to the motor vehicle 12 and a communication unit (also not shown here), by means of which data required for the adjustment procedure can be retrieved, for example from an external database. The adjustment unit 1 can be controlled via an operating unit 7, which comprises a display 8. A signaling light 9 arranged on the operating unit 7 serves to signal operation of the adjustment unit 1.

The chassis 4 comprises rollers 10 for moving the adjustment unit 1. By means of the drive of said rollers, the adjustment unit 1 can be both displaced and rotated. An emergency shut-off ii makes it possible to immediately interrupt the adjustment procedure in the event of a fault.

### LIST OF REFERENCE SIGNS

1 Adjustment unit
2 Base support
3 Orientation element
4 Chassis
5 Battery module
6 Sensor modules
7 Operating unit
8 Display
9 Signaling light
10 Rollers
11 Emergency shut-off
12 Motor vehicle

1. An adjustment unit for orienting vehicle sensors and/or cameras on a motor vehicle, comprising
a base support for adjustably receiving an orientation element,
a travel unit connected to the base support,
a position detection unit connected to the travel unit for determining the position of the orientation element relative to the vehicle sensors and/or cameras, and
a central control unit for automatically controlling and orienting the travel unit and the orientation element relative to the motor vehicle.

2. The adjustment unit according to claim 1, wherein the orientation element is connected to an actuator that is arranged on the base support and that is connected to the control unit.

3. The adjustment unit according to claim 1, wherein the control unit is connected to a communication unit for wireless data exchange.

4. The adjustment unit according to claim 1, wherein the control unit is connected to a scanning unit for measuring and/or identifying a motor vehicle.

5. The adjustment unit according to claim 1, wherein the control unit is connected to an obstacle detection unit.

6. The adjustment unit according to claim 1, wherein the position detection unit comprises a device for measuring the path.

7. The adjustment unit according to claim 1, characterized by a signaling unit for protecting the surroundings.
